(19) United States
(12) Patent Application Publication
(10) Pub. No.: US 2009/0294117 A1
(43) Pub. Date: Dec. 3, 2009

(54) Vapor Chamber-Thermoelectric Module Assemblies

(75) Inventors: Marc S. Hodes, Dublin (IE); Alan M. Lyons, New Providence, NJ (US)

Correspondence Address: HITT GAINES, PC;ALCATEL-LUCENT, PO BOX 832570, RICHARDSON, TX, 75083, US

(73) Assignee: Lucent Technologies, Inc., Murray Hill, NJ (US)

(21) Appl. No.: 12/128,478

(22) Filed: May 28, 2008

(51) Int. Cl. F28D 15/00; G05D 23/00

(52) U.S. Cl. 165/287; 165/104.34

(57) ABSTRACT

An apparatus includes a body containing a vapor chamber and having first and opposing second major surfaces and a thermoelectric module having first and opposing second major surfaces. The second major surface of the body is in thermal contact with the first major surface of the thermoelectric module. A heat sink has a first major surface in thermal contact with the second major surface of the thermoelectric module. The thermoelectric module is configured to control a flow of heat between the body and the heat sink.

### TECHNICAL FIELD OF THE INVENTION

The invention is directed, in general, to a thermoelectric module.

### BACKGROUND OF THE INVENTION

Thermoelectric modules (TEMs) are a class of semiconductor-based devices that may be used to, e.g., heat or cool an object, or may be used to generate power when placed in contact with a hot object. Generally, semiconductor pellets of alternating doping type are arranged in series electrically and in parallel thermally. As current flows through the pellets, one side of the TEM becomes colder, and the other warmer. Conversely, when placed in a thermal gradient, the TEM may drive a current through a load. TEMs have been used to cool a device, or to maintain an operating temperature with the aid of a feedback control loop.

### SUMMARY OF THE INVENTION

The invention provides an apparatus including a body containing a vapor chamber and having first and opposing second major surfaces, and a thermoelectric module having first and opposing second major surfaces. The second major surface of the body is in thermal contact with the first major surface of the thermoelectric module. A heat sink has a first major surface in thermal contact with the second major surface of the thermoelectric module. The thermoelectric module is configured to control a flow of heat between the body and the heat sink.

Another embodiment is a method that includes providing a body containing a vapor chamber and having first and opposing second major surfaces, a thermoelectric module having first and opposing second major surfaces and a heat sink having a first major surface. The first major surface of the thermoelectric module is placed in thermal contact with the second major surface of the body. The first major surface of the heat sink is placed in thermal contact with the second major surface of the thermoelectric module. The method includes configuring the thermoelectric module to control a flow of heat between the body and the heat sink.

Another embodiment is a system including a body containing a vapor chamber and having first and opposing second major surfaces. A thermoelectric module has first and opposing second major surfaces. The second major surface of the body is in thermal contact with the first major surface of the thermoelectric module. A heat sink has a first major surface in thermal contact with the second major surface of the thermoelectric module. A device configured to produce heat is in thermal contact with the first major surface of the body. The thermoelectric module is configured to control a flow of heat between the device and the heat sink.

### BRIEF DESCRIPTION OF THE DRAWINGS

For a more complete understanding of the invention, reference is now made to the following descriptions taken in conjunction with the accompanying drawings, in which:

FIG. 1 illustrates a prior art configuration of a device and a solid heat spreader;

FIG. 2 illustrates a configuration of a device and a vapor chamber heat spreader in accordance with the invention;

FIG. 3 illustrates a TEM;

FIG. 4 illustrates an embodiment in accordance with the invention;

FIGS. 5A and 5B illustrate internal function of a vapor chamber body;

FIGS. 6A, 6B and 6C illustrate operating modes of a TEM;

FIG. 7 illustrates a device and a vapor chamber body;

FIG. 8 illustrates a temperature distribution;

FIG. 9 illustrates operating characteristics of a TEM;

FIG. 10 illustrates an embodiment having multiple TEMs placed in contact with a vapor chamber body;

FIG. 11 illustrates a vapor chamber integrated with a TEM; and

FIG. 12 illustrates an embodiment including a variable conductance heat conducting pipe.

### DETAILED DESCRIPTION

In the past, designers have placed a heat sink and a body containing a vapor chamber in direct thermal contact. As used herein, thermal contact refers to significant conduction of heat between two bodies or between one body and a cooling medium. Incidental or trivial heat transfer to air, e.g., is explicitly excluded from the usage of the term. Moreover, the term includes thermal coupling between two bodies that are separated by a thermally conducting layer, such as a thermal coupling aid (e.g., thermal grease) or a sufficiently thin insulator. In such designs priority is typically given to minimizing the thermal resistance between the vapor chamber and the heat sink, as evidenced by the common use of a thermally conductive pad or grease between them. But the thermal resistance between the heat sink and the vapor chamber in this configuration is invariant.

In other work, a solid copper heat spreader was attached to a heat-producing device. One heat sink was attached directly to the heat spreader, and another heat sink was attached to a TEM that was in turn attached to the heat spreader. See, e.g., G. L. Solbrekken, et al., “Heat Driven Cooling of Portable Electronics Using Thermoelectric Technology, IEEE Trans. Advanced Packaging, Vol. 31 No, 2, May 2008. Thus, in Solbrekken, cooling of the device included a low thermal-resistance heat transfer path from the device through the solid heat spreader and heat sink to the air. Moreover, the fraction of heat produced by the heat-producing device converted to power was small.

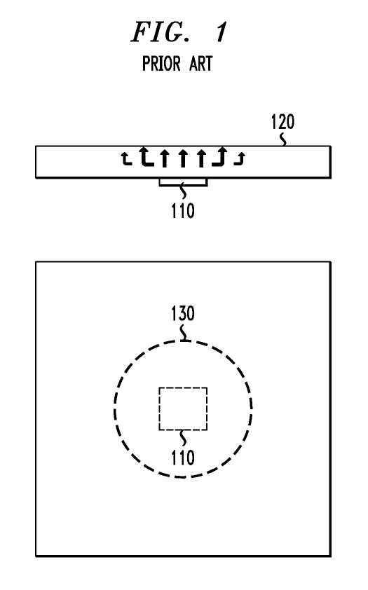

However, the effective size of a solid heat spreader is limited by spreading resistance due to finite lateral thermal conductivity. FIG. 1 illustrates a prior art configuration of a heat-generating device 110 and a solid heat spreader 120. The heat flow from the device 110 to the heat spreader 120 is direct within a footprint of the device 110 on the heat spreader 120, but flows laterally outside the footprint. Because the heat spreader 120 has a finite thermal conductivity, the rate of heat flow diminishes with increasing distance from the device 110, resulting in an effective spreading perimeter 130. The size of the perimeter 130 will depend on such factors as the magnitude of the heat flow from the device 110, and the thickness and thermal conductivity of the heat spreader 120. But outside the perimeter 130, a heat sink in thermal contact with the heat spreader 120 would not provide significant heat transfer to the ambient. Thus, the sizes of the heat spreader 120 and a heat sink attached to it are effectively limited to the extent of the perimeter 130. Thus, e.g., a solid heat spreader has a relatively limited ability to effectively increase the surface area available to interface to a heat sink to dissipate heat from an operating electronic device.

The pumping efficiency of a TEM typically is greater when the rate of heat flux (e.g., W/m²) therethrough is lower. Pumping efficiency typically, and as used herein, refers to a rate of heat transfer to or from the device divided by the power supplied to the TEM. Similarly, efficiency of power generation by the TEM refers to the ratio of power produced by the TEM to the heat supplied to it. The limited lateral extent of the effective portion of a solid spreader limits the ability of a designer to achieve a sufficiently low heat flux associated with a desired efficiency.

We have recognized that use of a vapor chamber as a heat spreader, instead of a simple metal slab, between a device and a large TEM or bank of TEMs overcomes the limitations of past practice. In some embodiments, described below, the vapor chamber heat spreader is in thermal contact only with a device and a TEM. This novel configuration provides a significant and unexpected increase in efficiency of the TEM in temperature control and power generation applications.

Use of a vapor chamber instead of a solid heat spreader provides the means to effectively extend the heat flow to include the extremities of a large TEM or bank of TEMs, (e.g., 10× the size of the device or more), and a heat sink attached to the TEM or TEMs. The ability to extend the lateral flow of heat in turn provides a means to reduce heat flow density through the TEM(s) so that the TEM(s) may be operated in a more efficient operating regime. Thus, e.g., generation of waste heat by the TEM may be advantageously reduced in heating or cooling mode, or a greater fraction of power from waste heat in a system may be recovered to produce useful work in the system.

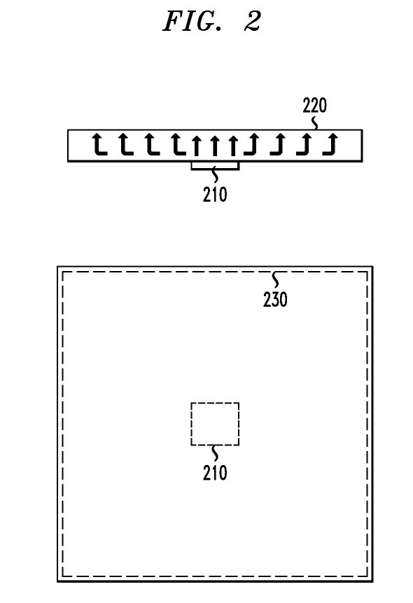

FIG. 2 illustrates a heat generating device 210 in thermal contact with a body 220 that encloses a vapor chamber. As described in greater detail below, the body 220 operates by using a vaporization-condensation cycle of a working fluid to result in a greater lateral thermal conductivity than the solid heat spreader 120. The vertical thermal conductivity of the heat spreader 220 is typically much lower than that of the solid heat spreader 120 formed from copper, but the lateral conductivity may be, e.g., 10×-100× the lateral conductivity of a solid heat sink. The high lateral conductivity effectively results in an effective spreading perimeter 230 almost equal to the lateral extent of the heat spreader 220. Thus the lower vertical thermal conductivity may be more than offset by the increased useful surface area of a heat sink(s) made possible by the greater lateral thermal conductivity. Moreover, the heat is transferred from the device 210 to the upper surface in a more uniform manner than with the solid heat spreader 120. Thus, when the surface of the heat spreader 220 opposing the surface in thermal contact with the device is placed in thermal contact with a TEM, e.g., the TEM sees a more uniform distribution of heat flow at its surface.

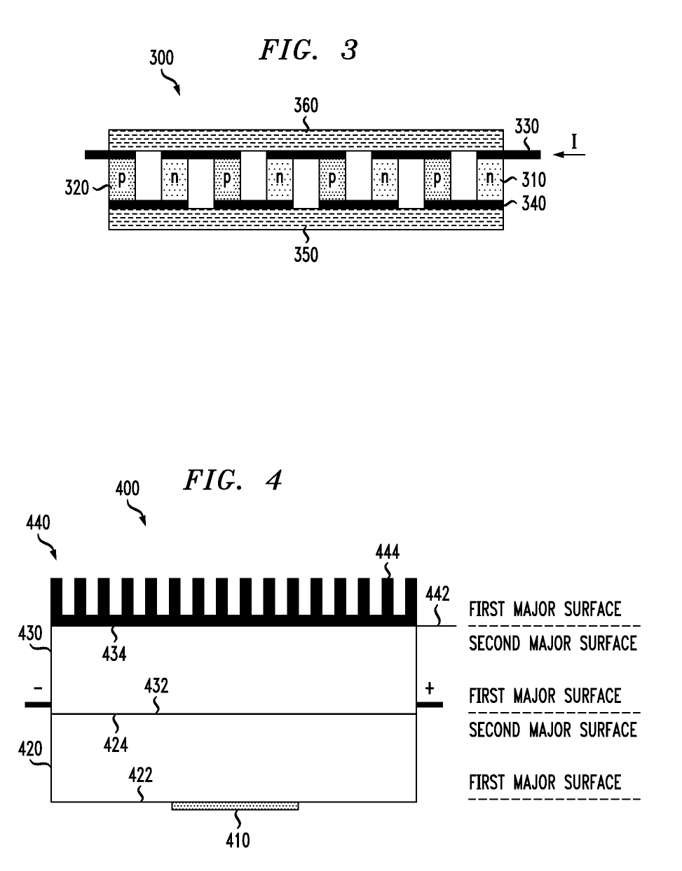

Turning to FIG. 3, illustrated is an example TEM 300. The TEM 300 includes n-doped pellets 310 and p-doped pellets 320. The pellets 310, 320 are connected by a first set of electrodes 330 and a second set of electrodes 340. The pellets 310, 320 and electrodes 330, 340 are configured to be electrically in series and thermally in parallel. A lower substrate 350 and an upper substrate 360 serve to electrically isolate the TEM 300 from an object with which the TEM 300 is placed in thermal contact, and to provide mechanical strength. During operation the flow of a current I produces a positive thermal gradient in the direction of the current flow across the n-doped pellets 310, and opposite the direction of current flow across the p-doped pellets 320. The substrates 350, 360 may be formed from an electrically insulating ceramic with a sufficiently high thermal conductivity, such as, e.g., alumina (Al₂O₃), aluminum nitride (AlN) and beryllia (BeO).

As mentioned previously, the efficiency of heat transfer by the TEM 300 decreases with increasing heat flux across the pellets 310, 320. The greater uniformity and lateral extent of heat transfer by the heat spreader 220 provides the ability to scale up the size of the heat spreader to limit the heat flux through the pellets 310, 320 to a value associated with increased efficiency. Because the heat spreader 220 provides much lower spreading resistance, the heat spreader can be made much larger to achieve the desired flux than can be done using the solid heat spreader 120.

Turning to FIG. 4, illustrated is an embodiment 400 in accordance with the aforementioned recognition. A device 410 is in thermal contact with a body 420 containing a vapor chamber. The body 420 has a first major surface 422 and an opposing second major surface 424. The device 410 is in thermal contact with the first major surface 422 of the body 420. The second major surface 424 of the body 420 is in thermal contact with a first major surface 432 of a TEM 430. An opposing second major surface 434 of the TEM 430 is in thermal contact with a first major surface 442 of a heat sink 440. In some embodiments, as in the illustrated embodiment, the second major surface 424 is only in thermal contact with the first major surface 432. Radiation and convective heat transfer from the TEM 430 with ambient air are neglected. The heat sink 440 has a second major surface 444 that forms an interface with a cooling fluid. The heat sink 440 is shown as, e.g., a finned heat sink, in which case the cooling fluid may be ambient air. The heat sink 440 could be a thermal sink of any other type as well, including, e.g., a liquid-cooled heat sink or a microchannel heat sink, and may or may not include fins. The TEM 430 may be a conventional TEM with rectangular geometry, or may have an unconventional geometry such as, e.g., a radial geometry. See, e.g., U.S. patent application Ser. No. 11/618,056, incorporated herein by reference.

The major surfaces 422, 424 of the body 420 are the surfaces that collectively include the majority of the outer surface area of the body 420. The major surfaces 432, 434 of the TEM 430 are defined similarly. The first major surface 442 of the heat sink 440 is a substantially smooth surface thereof configurable to place the heat sink 440 in thermal contact with the TEM 430. In some cases the major surfaces are substantially planar to facilitate placing one element, e.g., the body 420, in thermal contact with a neighboring element, e.g., the TEM 430. The major surfaces need not be planar, but could instead be, e.g., curved to conform to the shape of the device 410.

The device 410 may be any device configured to dissipate heat, such as, e.g., an electronic component configured to dissipate power when operating. Without limitation, examples of such devices include power amplifiers, microprocessors, optical amplifiers, and some lasers. Some of such devices may dissipate 100 W or more, and may reach a temperature of 300-400 C.

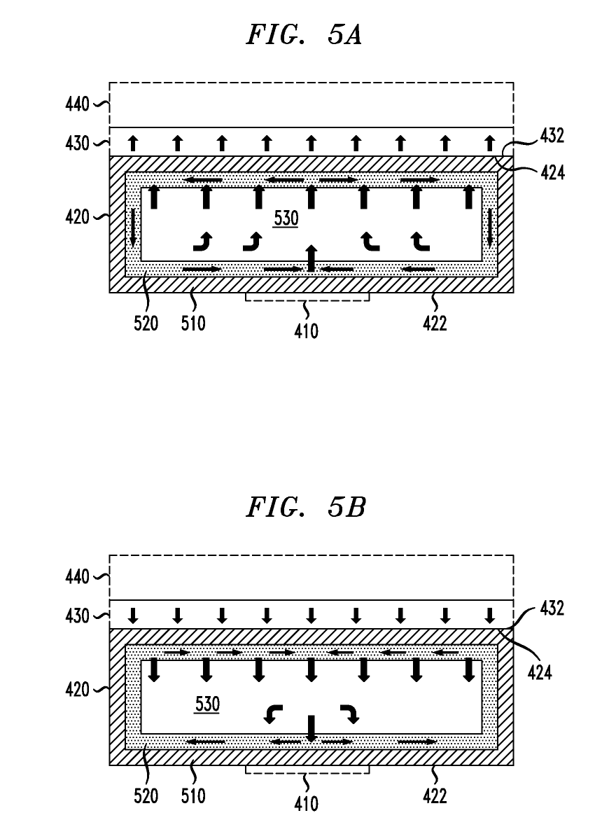

FIGS. 5A and 5B illustrate the body 420 in greater detail. FIG. 5A illustrates the body 420 cooperating with the TEM 430 to transport heat from the device 410 to the heat sink 440. A wall 510 defines an interior volume of the body 420 comprising a wick 520 and a vapor chamber 530. The wick 520 is wetted with a working fluid such as alcohol or water. The wall 510 provides structural support to the body 420 (sometimes in addition to internal structural supports, not shown), and has sufficient thermal conductivity to ensure that the body 420 has a low thermal resistance between the major surfaces 422, 424. The thermal conductivity of the wall 510 is high enough that heat is effectively conducted between the device 410 and the wick 520, and between the wick 520 and the TEM 430. The wall 510 also provides some lateral spreading before heat is conducted into the wick 520, which typically has a much lower thermal conductivity. The wall 510 may be formed from materials having a thermal conductivity of about 200 W/m-K or higher, such as, e.g., copper or aluminum. A commercially available example of such a body 420 is the Therma-Base™ vapor spreader manufactured by Thermacore International Co., Lancaster Pa.

The wall 510 is lined at least partially with the wick 520. The wick 520 may be, e.g., a porous metal such as sintered copper, metal foam or screen, or an organic fibrous material. When the TEM 430 is configured to cool the device 410, the working fluid evaporates from the wick 520 to a vapor in the vapor chamber 530 and carries energy from the vicinity of the device 410 by virtue of the heat of vaporization associated with the phase change. The vapor diffuses through the vapor chamber 530 and condenses at a liquid-vapor interface on the wick 520 proximate the second major surface 424, thereby transferring the heat of condensation of the working fluid to the larger area of the second major surface 424. The condensed working fluid then cycles in the wick 520 to the region proximate the device 410 by capillary action.

FIG. 5B illustrates the operation of the body 420 for the case that the TEM 430 is configured to transport heat from the heat sink 440 to the device 410. In this case, the working fluid evaporates from the wick 520 proximate the second major surface 424 and condenses on the wick 520 proximate the first major surface 422. Heat is then conducted through the wall 510 thus transporting heat to the device 410. Condensation is thought to be greater in the region of the wick 520 proximate the device 410 when the device 410 is at a lower temperature than the major surface 422 outside the footprint of the device 410. Thus, in this case heat supplied by the TEM 430 is concentrated near the device 410. Transporting heat to the device 410 may be desirable, e.g., when controlling the temperature of the device 410 by active feedback. Active control of the temperature of the device 410, if used, may employ conventional or future-discovered method, such as, e.g., pulse width modulation or proportional control.

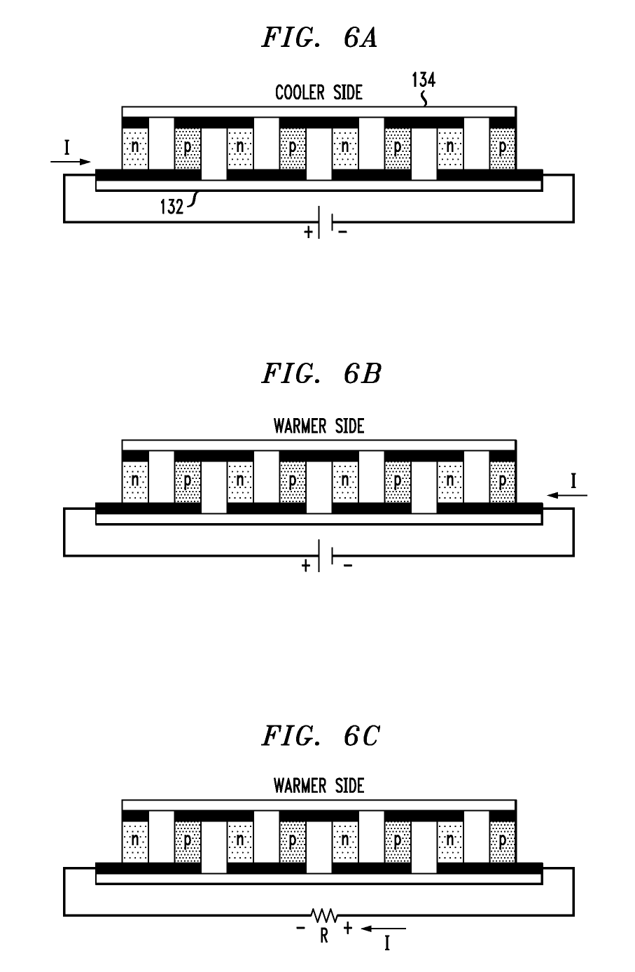

The direction of current flow through the TEM 430 determines which side of the TEM 430 is cooler. Referring to FIG. 6A, a power source is configured such that the direction of current flow (by convention opposite the direction of electron flow) is from the top to the bottom of the n-doped doped pellets. Hole flow is from the top to the bottom of the p-doped pellets. As a result, the top side of the illustrated TEM becomes cooler than the bottom side. In FIG. 6B, the direction of current flow is reversed, so the bottom side becomes cooler than the top side. In FIG. 6C, the case of power generation by the TEM is illustrated. When the top side of the TEM configured as shown is made warmer than the bottom side, the TEM develops a voltage potential that may drive a current with the direction shown. The current can be used to drive a resistive load R to perform work directly or after conversion to a desired voltage.

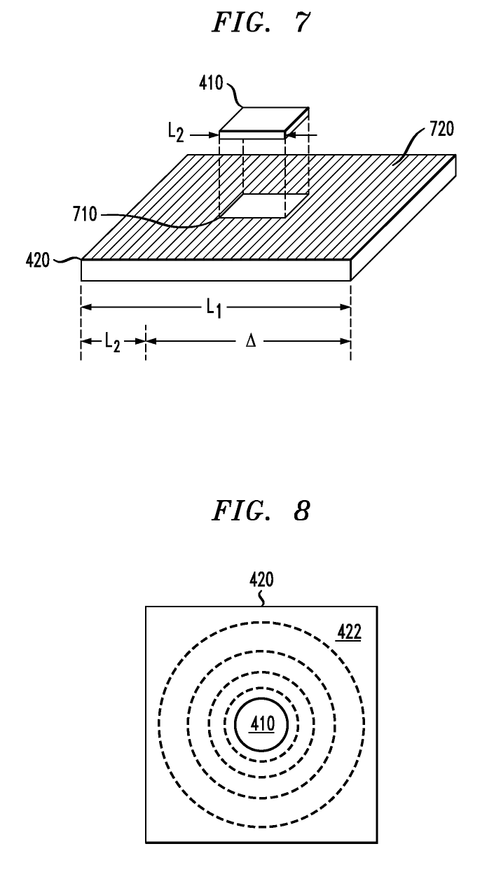

FIG. 7 illustrates the relative areas of the device 410 and the body 420. The case of a square device 410 and a square body 420 are illustrated without limitation. The body 420 has a side length L₁, and the device 410 has a side length L₂. An area 710 describes the area of contact between the device 410 and the body 420. A difference area 720 describes the portion of the surface of the body 420 uncontacted by the device 410. The ratio of the difference area 720 to the contact area 710 is the spreading ratio associated with the combination of the device 410 and body 420.

The difference area 720 can be expressed as Δ²+2ΔL₂, where Δ=L₁−L₂. Above Δ=2L₂, the difference area 720 increases about as the square of Δ. Thus, the spreading of the heat from the device 410 rapidly increases as Δ increases above 2L₂. A spreading factor is defined as the ratio of the difference area 720 divided by the area 710. In one embodiment, L₁ is about seven times L₂ or greater, resulting in a spreading factor of at least about 50. In another embodiment, L₁ is about 10 times L₂ or greater, resulting in a spreading factor of at least about 100. Similar results are obtained for a circular device 410 and body 420.

In another embodiment, heat is transferred between the heat sink 440 and the device 410 while the device is unpowered. For example, the device 410 may be cool prior to being powered, or may be warm after operation. It may be desirable, e.g., to pre-warm an optical device so that it will operate in a calibrated temperature range at startup. The TEM 430 may also operate cooperatively with the body 420 to limit the rate of temperature change when desired. In cases in which the device 410 is warm, e.g., the TEM 430 may be used to thermally insulate the device 410 from the heat sink 440 and/or controlled to remove heat at a slower rate than would occur if the device 410 and the heat sink 440 were thermally coupled by a low resistance path. In cases in which the TEM 430 is configured to transport heat to the device 410, the total power available to heat the device 410 is greater than the power that would be available if the TEM 430 and the device 410 had the same area.

FIG. 8 illustrates without limitation by theory a temperature profile at the first major surface of the body 422. For simplicity the device 410 is illustrated as having a circular shape. When the TEM 430 operates in heating mode, i.e., causes heat to flow from the second major surface 434 to the first major surface 432, the temperature of the device 410 is a local minimum. The temperature increases with distance from the device 410. Condensation of the working fluid in the vapor chamber is expected to be greater in areas with lower temperature. Conversely, when the TEM 430 operates in cooling mode, i.e., causes heat to flow from the first major surface 432 to the second major surface 434, the temperature of the device 410 is a local maximum. The temperature decreases with distance from the device 410. Evaporation of the working fluid in the vapor chamber is expected to be greater in areas with higher lower temperature.

In one embodiment, the external heat flux imposed on individual pellets of the TEM is limited to a value below which the TEM may operate efficiently. For example, the heat flux may be limited to a value below which Joule heating contributes significantly to the heat flux through the TEM. The heat flux may be limited by selecting the area of the first major surface 422 of the body 420 relative to area of the device 410 so that a rate of heat flow through individual pellets 310, 320 does not exceed a maximum value. Efficiency of heat transport is limited in part by dissipation of power in the pellets due to the control current flow. The current causes Joule (I²R) heating in the pellets that adds to the heat that must be extracted from the system and decreases the effectiveness of the pellets 310, 320 at transporting heat.

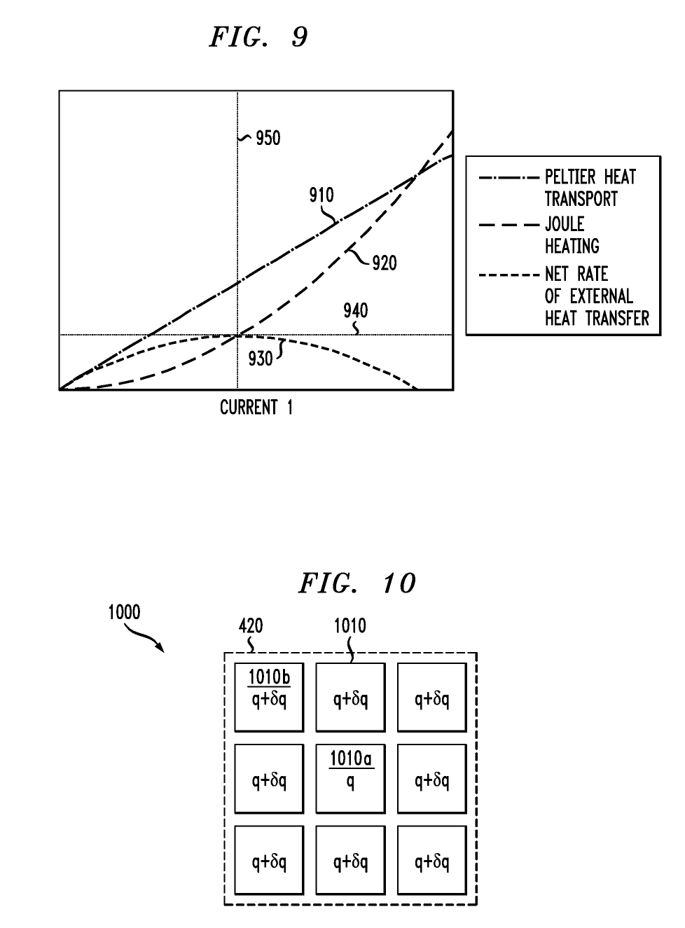

These competing factors are illustrated in FIG. 9, in which TEM characteristics in arbitrary units are plotted as a function of current I through a TEM. As the current I increases, an approximately linear characteristic 910 describes Peltier heat absorption from one pellet interface (e.g., the interface between the pellet 310 and the electrode 330) and Peltier heat released from the other pellet interface (e.g., the interface between the pellet 310 and the electrode 340). Thus, Peltier heat absorption increases with increasing current. The Joule heating increases with an approximately square-law characteristic 920. Thus, a net rate 930 of external heat transfer from the TEM at the device side exhibits a maximum value 940 at a control current 950. The control current 950 is referred to hereinafter as Iₘₐₓ. The performance may be, e.g., the temperature difference ΔT between warmer and cooler sides of the TEM or the rate q of heat pumped across the cooler side. At Iₘₐₓ, these performance metrics are referred to as ΔTₘₐₓ and qₘₐₓ, respectively.

In some embodiments, the TEM 430 is configured such that qₘₐₓ is selected to be about equal to a maximum design power dissipation of the device 410. The maximum design power dissipation is the power dissipation expected from the device 410, such as the specified power dissipation of an electronic component at a maximum design voltage. In general, a lower control current through a TEM pellet is associated with greater efficiency of operation of the pellet, and of a TEM assembled from multiple pellets. In some embodiments, the TEM is operated with a current about 50% of Iₘₐₓ or less. In other embodiments, the TEM is operated with a current about 10% of Iₘₐₓ or less. In still other embodiments, the TEM is operated with a current about 5% of Iₘₐₓ or less. In some cases, the TEM is operated with a current about 1% of Iₘₐₓ or less. In general, Iₘₐₓ, ΔTₘₐₓ and qₘₐₓ of a particular TEM will depend on the specific design parameters of that TEM.

The performance characteristics of the TEM 430 configured to generate power are similar to those illustrated in FIG. 8. Thus, the efficiency of power generation also increases with decreasing current through individual pellets of the TEM. The spreading of heat flow by the body 420 is therefore advantageous in power generation mode.

Turning to FIG. 10, illustrated is an embodiment having multiple TEMs 1010, each with first and opposing second major surfaces. The TEMs 1010 are divided into a first subset 1010a (one TEM in this example), and a second subset 1010b. The first major surface of each thermoelectric module is in thermal contact with the second major surface 424 of the body 420. The area of the first major surface of each TEM 1010 is less than the area of the body 420. In some embodiments, a single heat sink (not shown) is attached to more than one TEM 1010, while in other embodiments each TEM 1010 is attached to an individual heat sink.

A TEM generally experiences bowing due to differential expansion of the hot and cold sides. This effect typically limits the TEM to a maximum footprint of about 2 inches×2 inches, above which the bowing would result in mechanical failure. In an embodiment, multiple TEMs are used to obviate the risk of such mechanical failure. Nine individual TEMs 1010 are shown in the illustrated embodiment, but greater or fewer TEMs could be used as required by a particular design. It should be noted that a solid heat spreader would not in general provide low enough spreading resistance to provide about the same heat flow to the second subset 1010b as the first subset 1010a.

In some embodiments having multiple TEMs in thermal contact with the body 420, each TEM 1010a, 1010b is configured to be in thermal contact with a portion of a heat sink, e.g., the heat sink 440, having localized heat transfer characteristics. For example, the heat sink 440 may have a first portion configured to have a first rate of heat transfer to a cooling medium and a second portion configured to have a second rate of heat transfer to the cooling medium that is greater than the first rate. Such may be the case, e.g., where a peripheral portion of the heat sink 440 has a greater rate of heat transfer to the ambient than does an interior portion. In an embodiment, the TEM 1010a is configured to have a first rate, q, of heat transport over a unit area, and the TEMs 1010b are configured to have a second rate, q+δq, of heat transport over a unit area that is greater than the first rate. Thus, e.g., heat from a heat producing device may be directed to those portions of the heat sink 440 configured to transfer heat to the ambient at a greater rate to increase overall heat flow.

In some cases, TEMs in thermal contact with peripheral portions of a heat sink, e.g., TEMS 1010b, may be configured to operate with a different efficiency than TEMs in thermal contact with the interior portions of the heat sink, e.g., TEMs 1010a. Such may be the case when operation of the TEMS 1010a, 1010b at different heat transfer rates places the operation thereof at different points on the Peltier heat transport characteristic 910. In some cases, the TEMs 1010a, 1010b may be individually controlled electrically in heating and/or cooling modes, to produce different heat transport rates therethrough. Thus, the TEMs 1010a, 1010b may be configured to control a distribution of heat over the first major surface 442 of the heat sink. When configured for power generation, each TEM 1010a, 1010b may be configured, e.g., in series or parallel as desired to result in a desired power/voltage relationship.

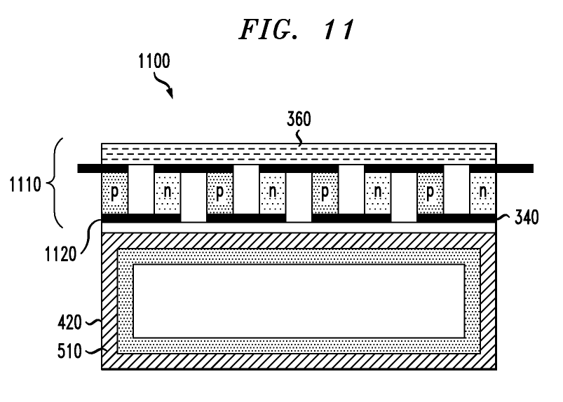

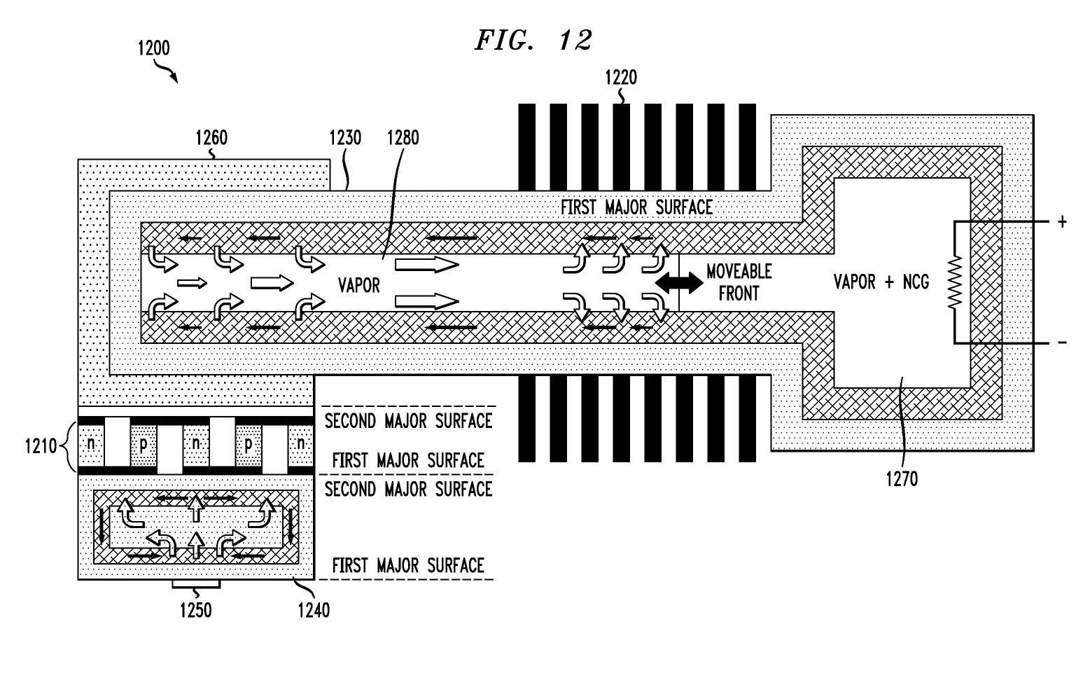

Turning to FIG. 11, illustrated is an embodiment of an integrated TEM/vapor chamber 1100. The integrated TEM/vapor chamber 1100 includes a TEM 1110 and the body 420. The wall 510 forms a substrate of the TEM 1110, meaning the wall 510 is formed as an integral substrate of the TEM. This configuration eliminates a thermal interface present when the discrete TEM 430 and body 420 are placed in physical contact. Elimination of the thermal interface is expected to decrease thermal resistance between the TEM 1110 and the body 420 relative to the case where the body 420 is not integrated into a TEM substrate. It may also decrease the height of the assembly. Reduction of height is advantageous when stack-up heights are constrained as for, e.g., telecommunications circuit packs. In cases in which the wall 510 includes a ceramic outer layer, electrodes 340 of the TEM 1110 may be formed directly on the wall 510. In cases in which the wall 510 is formed from a conductor, an optional thin insulating film 1120 may be interposed between the TEM 1110 and the body 420. The film 1120 may be, e.g., a polyimide film such as Kapton®. In these embodiments, the electrodes 340 may be formed directly on the film 1120 as part of the fabrication process.

As discussed earlier, the TEM 430 may be configured to produce electrical power from the waste heat dissipated by the device 410. In the past, the package temperature of electronic devices has generally not exceeded about 100 C. The efficiency of power generation by a TEM is generally relatively low, e.g., less than about 10%. If the temperature of the device 410 is less than 100 C, the efficiency of power conversion using a TEM is typically too low to recover useful amounts of power. However, the efficiency is typically greater when the temperature of the junction at the pellet-electrode interface is higher. Also, the efficiency is expected to be greater when the temperature difference between the warm and cold sides of the TEM is greater.

Some electronic devices, e.g., some emerging power amplifiers based on silicon carbide, are expected to be configured to have an operating temperature ranging from about 350 C to about 400 C. The maximum conversion efficiency of the TEM 430 is expected to be about 5% to 7.5% in the range of 350 C to 400 C assuming, without limitation, a 20 C cold side for current thermoelectric materials with a figure of merit ZT=2αT/(4*k*ρ) of about 0.5, where α is the difference in Seebeck coefficient of p-type and n-type pellets, k is thermal conductivity of the pellets, ρ is electrical resistivity of the pellets and T is temperature in Kelvins. For emerging thermoelectric materials, such as superlattices, e.g., the maximum conversion efficiency is expected to be about 20% in this temperature range. Actual TEMs will in general have different efficiency characteristics. This fraction of recoverable power is considered to be large enough to justify the expense of recovery. Current from the TEM 430 operated in power generating mode may be converted by conventional means to a desired voltage and used in the system where needed.

Turning to FIG. 12, an embodiment 1200 is illustrated in which a TEM 1210 is thermally coupled to a heat sink 1220 by a variable resistance heat transfer device 1230. In the illustrated embodiment, the variable resistance heat transfer device 1230 is, e.g., a variable conductance heat pipe (VCHP). Details of a variable resistance heat transfer device can be found in U.S. Pat. No. 7,299,859 B2, to Bolle, et al., “Temperature Control of Thermooptic Devices,” incorporated by reference herein. A body 1240 optionally is integrated with the TEM 1210 so that the body 1240 forms a substrate of the TEMP 1210. A device 1250 is mounted on a major surface of the body 1240. The TEM 1210 is mounted on a thermally conductive block 1260 in which the end of the variable resistance heat transfer device 1230 is inserted.

The variable resistance heat transfer device 1230 operates on the principle of changing the volume of a mixture of a noncondensable gas (NCG) such as argon and the vapor of a working fluid in a reservoir 1270 to vary the volume of the pure vapor phase 1280 of the working fluid. Thus the coupling of the TEM 1210 to the heat sink 1220 may be controllably varied.

The variable resistance heat transfer device 1230 provides a means to decrease the thermal resistance between the TEM 1210 and the heat sink 1220 when, e.g., the heat dissipation of the device decreases. In addition, the controlled variability of the thermal contact between the TEM 1210 and the heat sink 1220 may be exploited advantageously. In an embodiment, the variable resistance heat transfer device 1230 is used to coordinate the thermal coupling between the TEM 1210 and the heat sink 1220 with the operational mode of the TEM 1210. Thus, in an embodiment, the coupling is increased when the TEM 1210 is configured to cool the device 1250, and decreased when the TEM 1210 is configured to heat the device 1250.

Those skilled in the art to which the invention relates will appreciate that other and further additions, deletions, substitutions and modifications may be made to the described embodiments without departing from the scope of the invention.

What is claimed is:

1. An apparatus, comprising:
a body containing a vapor chamber and having first and opposing second major surfaces,
a thermoelectric module having first and opposing second major surfaces, said second major surface of said body being in thermal contact with said first major surface of said thermoelectric module; and
a heat sink having a first major surface in thermal contact with said second major surface of said thermoelectric module, said thermoelectric module configured to control a flow of heat between said body and said heat sink.

2. The apparatus as recited in claim 1, wherein said second major surface of said body is in thermal contact only with said first major surface of said thermoelectric module.

3. The apparatus as recited in claim 1, wherein said thermoelectric module is further configured to control a distribution of said heat over said first major surface of said heat sink.

4. The apparatus as recited in claim 1, wherein said vapor chamber and said thermoelectric module are an integrated assembly in which said body forms a substrate of said thermoelectric module.

5. The apparatus as recited in claim 1, further comprising a plurality of thermoelectric modules each having first and opposing second major surfaces with an area less than an area of said second major surface of said body, wherein said first major surface of each thermoelectric module is in thermal contact with said second major surface of said body.

6. The apparatus as recited in claim 5, wherein a thermoelectric module in a first subset of said plurality is configured to have a first rate of heat transport over a unit area, and a thermoelectric module in a second subset of said plurality is configured to have a second rate of heat transport over a unit area that is greater than said first rate.

7. The apparatus as recited in claim 6, wherein said heat sink comprises a first portion configured to have a first rate of heat transfer to a cooling medium and a second portion is configured to have a second rate of heat transfer to said cooling medium that is greater than said first rate, and a thermoelectric module in said second subset is in thermal contact with said second portion.

8. The apparatus as recited in claim 1, wherein said thermoelectric module is configured to provide power to a load in response to heat dissipated by a device in thermal contact with said first major surface of said body.

9. The apparatus as recited in claim 1, further comprising a variable resistance heat transfer device, wherein said second major surface of said thermoelectric module and said first major surface of said heat sink are in thermal contact with said variable resistance heat transfer device.

10. A method, comprising:
providing a body containing a vapor chamber and having first and opposing second major surfaces,
providing a thermoelectric module having first and opposing second major surfaces;
providing a heat sink having a first major surface;
placing said second major surface of said body in thermal contact with said first major surface of said thermoelectric module; and
placing said first major surface of said heat sink in thermal contact with said second major surface of said thermoelectric module, said thermoelectric module configured to control a flow of heat between said body and said heat sink.

11. The method as recited in claim 10, further comprising placing said second major surface of said body in thermal contact only with said first major surface of said thermoelectric module.

12. The method as recited in claim 10, further comprising configuring said thermoelectric module to control a distribution of said heat over said first major surface of said heat sink.

13. The method as recited in claim 10, further comprising configuring said thermoelectric module to operate at a control current that ranges from about 10% or less of a current Iₘₐₓ at which a heat flux q delivered by said thermoelectric module to one of said first or second major surfaces thereof is about twice a power dissipated by said thermoelectric module when operated at said control current Iₘₐₓ.

14. The method as recited in claim 10, further comprising providing a plurality of thermoelectric modules each having first and opposing second major surfaces with an area less than an area of said second major surface of said body, and placing said first major surface of each thermoelectric module in thermal contact with said second major surface of said body.

15. The method as recited in claim 14, further comprising configuring a thermoelectric module in a first subset of said plurality to have a first rate of heat transport over a unit area, and configuring a thermoelectric module in a second subset of said plurality to have a second rate of heat transport over a unit area that is greater than said first rate.

16. The method as recited in claim 15, wherein said heat sink comprises a first portion configured to have a first rate of heat transfer to a cooling medium and a second portion configured to have a second rate of heat transfer to said cooling medium that is greater than said first rate, and further comprising placing said thermoelectric module in said second subset in thermal contact with said second portion.

17. The method as recited in claim 10, further comprising configuring said thermoelectric module to provide power to a load in response to heat dissipated by a device in thermal contact with said first major surface of said body.

18. The method as recited in claim 10, further comprising:
placing said second major surface of said thermoelectric module and said first major surface of said heat sink in thermal contact with a variable resistance heat transfer device; and
configuring said variable resistance heat transfer device to provide a greater thermal coupling between said thermoelectric module and said heat sink when said thermoelectric module is configured to transport heat from said second major surface thereof to said first major surface thereof, and a lesser thermal coupling between said thermoelectric module and said heat sink when said thermoelectric module is configured to transport heat from said first major surface thereof to said second major surface thereof.

19. A system, comprising:
a body containing a vapor chamber and having first and opposing second major surfaces,
a thermoelectric module having first and opposing second major surfaces, said second major surface of said body being in thermal contact with said first major surface of said thermoelectric module;
a device configured to produce heat in thermal contact with said first major surface of said body, and
a heat sink having a first major surface in thermal contact with said second major surface of said thermoelectric module, said thermoelectric module configured to control a flow of heat between said device and said heat sink.

20. The system as recited in claim 19, further comprising an active controller configured to maintain a temperature of said device at a desired value.
